(19) United States
(12) Patent Application Publication
(10) Pub. No.: US 2025/0379378 A1
(43) Pub. Date: Dec. 11, 2025

(54) LOW-FORCE HIGH MATING DURABILITY OPEN-ENDED COMPLIANT PC TAIL CONTACT SYSTEM

(71) Applicant: ITT Manufacturing Enterprises LLC, Stamford, CT (US)

(72) Inventors: Michael Santos FINONA, Fountain Valley, CA (US); Hung Duc TRAN, Santa Ana, CA (US)

(73) Assignee: ITT Manufacturing Enterprises LLC, Stamford, CT (US)

(21) Appl. No.: 19/051,548

(22) Filed: Feb. 12, 2025

Related U.S. Application Data
(60) Provisional application No. 63/658,362, filed on Jun. 10, 2024.

(51) Int. Cl. H01R 12/58; H01R 12/70; H01R 12/72

(52) U.S. Cl. CPC H01R 12/585; H01R 12/7005; H01R 12/721

(57) ABSTRACT

A printed circuit (PC) tail contact includes a low-force, high mating durability, open-ended, compliant portion. The PC tail contact is structured with a contact portion to mate with a corresponding contact of another connector, a shoulder portion coupled to the contact portion to position the PC tail contact within the insulator of the PCB connector, a tail portion coupled to the shoulder portion, and the compliant portion coupled to the tail portion. The compliant portion may include two, three, or four deflectors with an open slit based on one or more of an internal diameter of a PCB through-hole or a current to be carried by the PC tail contact.

### CROSS-REFERENCE TO RELATED APPLICATIONS

This application claims priority to U.S. Provisional patent application Ser. No. 63/658,362 filed on Jun. 10, 2024. The disclosures of the Provisional Application are hereby incorporated by reference in their entirety.

### BACKGROUND

Unless otherwise indicated herein, the materials described in this section are not prior art to the claims in this application and are not admitted as prior art by inclusion in thissection.

Connector systems provide electrical interconnection between different devices allowing exchange of data, control information, power, and other electrical signals. Depending on implementation, size, shape, pin numbers, and other characteristics of the connectors may vary. Some connector systems are for special environments such as hazardous environments, and may therefore include special sealing properties. Others may be shielded against electromagnetic interference. Pin numbers and sizes may also differ depending on the implementation such as expected current levels, number of signals to be exchanged, etc.

### SUMMARY

The present disclosure generally describes a low-force, high mating durability, open-ended, compliant printed circuit (PC) tail contact.

According to some examples, a compliant printed circuit (PC) tail contact includes a contact portion to mate with a corresponding contact; a shoulder portion coupled to the contact portion to position the PC tail contact within an insulator of a connector; a tail portion coupled to the shoulder portion; and a compliant pin coupled to the tail portion, the compliant pin comprising two or more deflectors with an open slit.

According to further examples, a printed circuit board (PCB) connector may include a connector shell; an insulator within the connector shell; and a plurality of printed circuit (PC) tail contacts positioned within the insulator. Each PC tail contact may include a contact portion to mate with a corresponding contact of another connector; a shoulder portion coupled to the contact portion to position the PC tail contact within the insulator of the PCB connector; a tail portion coupled to the shoulder portion; and a compliant portion coupled to the tail portion, the compliant portion comprising two, three, or four deflectors with an open slit based on one or more of an internal diameter of a PCB through-hole or a current to be carried by the PC tailcontact.

According to yet further examples, a method for assembling a printed circuit board (PCB) connector with a plurality of compliant PC tail contacts may include positioning a shoulder portion of each PC tail contact in an insulator of the PCB connector such that a contact portion of each PC tail contact coupled to the respective shoulder portion is positioned inside a connector shell and inserting a compliant portion of each PC tail contact into a corresponding PCB through-hole, thereby coupling the PCB connector and a PCB. Each shoulder portion may be coupled to a corresponding tail portion. Each tail portion may be coupled to a corresponding compliant portion. Each shoulder portion may be straight or angled, and each compliant portion may include two or more deflectors with an open slit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates perspective views of example low-force, high mating durability, open-ended, compliant PC tail contact and a conventional, closed-ended, compliant PC tail contact;

FIG. 2 illustrates dimensions of an example low-force, high mating durability, open-ended, compliant PC tail contact;

FIG. 3A illustrates perspective and close-up views of an example low-force, high mating durability, open-ended, compliant PC tail contact in 90-degree configuration;

FIG. 3B illustrates various perspective views of an example low-force, high mating durability, open-ended, compliant PC tail contact in straight configuration; and

FIG. 4 illustrates implementation of an example low-force, high mating durability, open-ended, compliant PC tail contact in a D-SUB type connector, arranged in accordance with at least some embodiments describedherein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplatedherein.

This disclosure is generally drawn, inter alia, to methods, apparatus, systems and/or devices related to a low-force, high mating durability, open-ended, compliant pin.

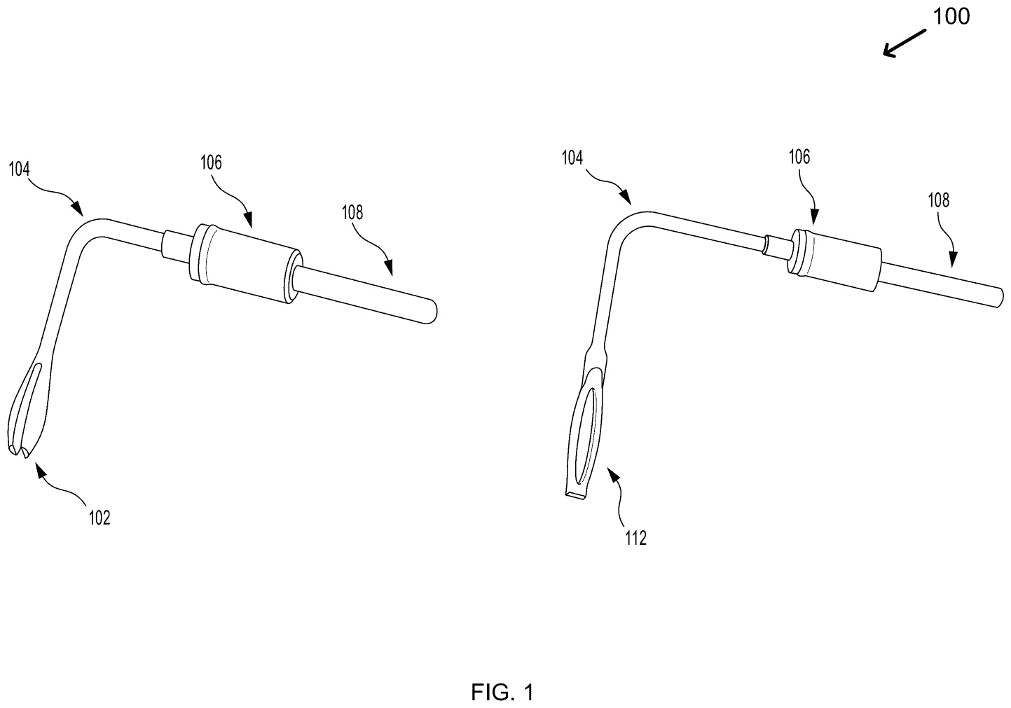

FIG. 1 illustrates perspective views of example low-force, high mating durability, open-ended, compliant PC tail contact and a conventional, closed-ended, compliant PC tail contact, arranged in accordance with at least some embodiments described herein.

Diagram 100 shows compliant printed circuit (PC) tail contact according to embodiments with a compliant portion 102, a 90-degree bend 104, a shoulder portion 106, and contact portion 108. Similarly, a conventional PC tail contact includes the contact portion 108, the shoulder portion 106, the bend 104, and a conventional compliant portion 112.

Many industries that use electronic connectors have adopted the application of compliant pin technology for the connector interface with the printed circuit board (PCB). PC tail contacts or compliant pins form a larger connector that is placed on a printer circuit board (PCB) providing signal and power interface for circuits on the PCB to external devices. Compliant pins, also known “press-fit” pins, include a compliant portion on the end of the contact that interfaces with the inside diameter of a through-hole of the PCB when “pressed” firmly into the PCB through-hole. Compliant pins eliminate complexities and costs of the soldering process. Both the PCB through-hole and the compliant section of the contact are typically plated with a conductive material. The compliant section of the pin is designed to provide a spring action that maintains a minimal acceptable normal force against the internal diameter of the PCB through-hole once inserted into the PCB, and thus maintains a good electrical contact of the pin with the PCB.

The end of the pin that fits into the PCB through-hole “complies” with the internal diameter of the through-hole; thus, the name “compliant pin”. In many designs, the compliant pin may also be extracted from the PCB through-hole for repairs or PCB replacement if needed. Because the compliant section of the terminal has a “spring” characteristic, it maintains an acceptable normal force against the internal diameter of the PCB through-hole over a variety of temperature ranges, vibration ranges, and impact-test ranges. Thus, even when temperature, vibration level, and impact vary significantly, the compliant pin maintains a good electrical contact with the PCB through-hole, while a solder joint may crack or break with variations of temperature and vibration.

As shown in more detail below, the compliant portion 102 of the PC tail contact includes an open-ended slit, which may be bifurcated, three-pronged, or quad-pronged depending on an internal diameter of the PCB through-hole and/or a current to be carried. The PC tail contact according to embodiments provides low insertion force, 0.003-0.004 beam deflection per side, a robust normal force through the use of a dial Hertzian Stress beam for low contact resistance, insertion and extraction durability, high current carrying capability (e.g., 3A to 5A). The compliant portion may be plated with tin, silver, or gold, for example. The current rating may be dependent on the number of contact points, geometry and shape; and thermal and electrical properties of material-commonly referred to as Current vs Temperature Rise. While the bend portion 104 is shown with a 90-degree angle, other angles may also be used such as 0 degree, 45 degrees, and others. The contact portion 108 may be a pin or a socket depending on the gender of the connector. The shoulder portion 106 may be used to position the PC tail contact into an insulator of a connector. Thus, dimensions of the shoulder portion 106 (e.g., diameter, length) may be selected depending on an implementation, insulator size, connector size, number and layout of contacts, etc.

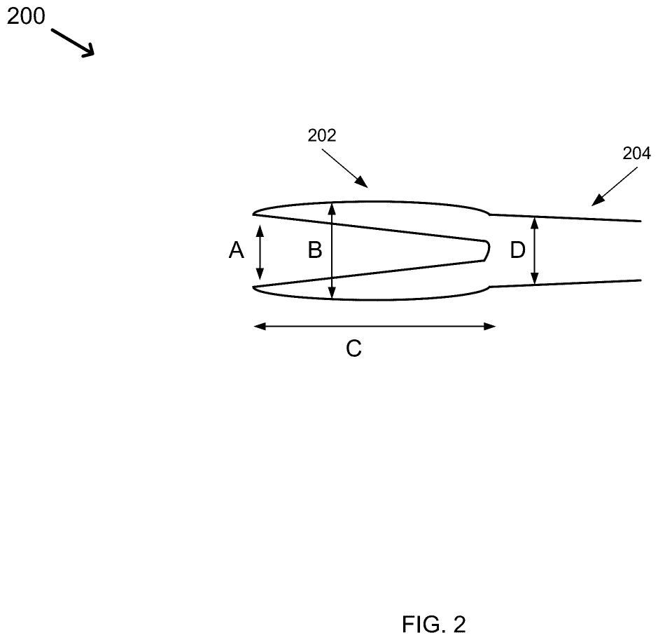

FIG. 2 illustrates dimensions of an example low-force, high mating durability, open-ended, compliant PC tail contact, arranged in accordance with at least some embodiments described herein.

As shown in diagram 200, the compliant portion 202 may have a length (C) with diameter (D) of the contact body 204, an external diameter (B) of the compliant portion 202, and an opening (A) of the compliant portion 202 at the tip. These dimensions may have values in ranges dependent on the elasticity and tensile strength of the material—commonly referred to as the Stress/Strain Material Analysis. The compliant portion 202 may provide 0.003-0.004 beam deflection per side. In an example implementation, the compliant portion may be formed with A=0.030 mil, B=0.050 mil, C=0.100 mil, and D=0.040 mil.

The open slit configuration and the shape of the deflectors (tines) may provide increased contact surface allowing heat and signal accommodation, decreased insertion force, and increased depth range (allowing shorter through-hole depths). The dimensions discussed herein may be selected depending on PCB through-hole internal diameter and depth, number of contacts in the connector (density), application requirements, symmetry, spacing, or otherconsiderations.

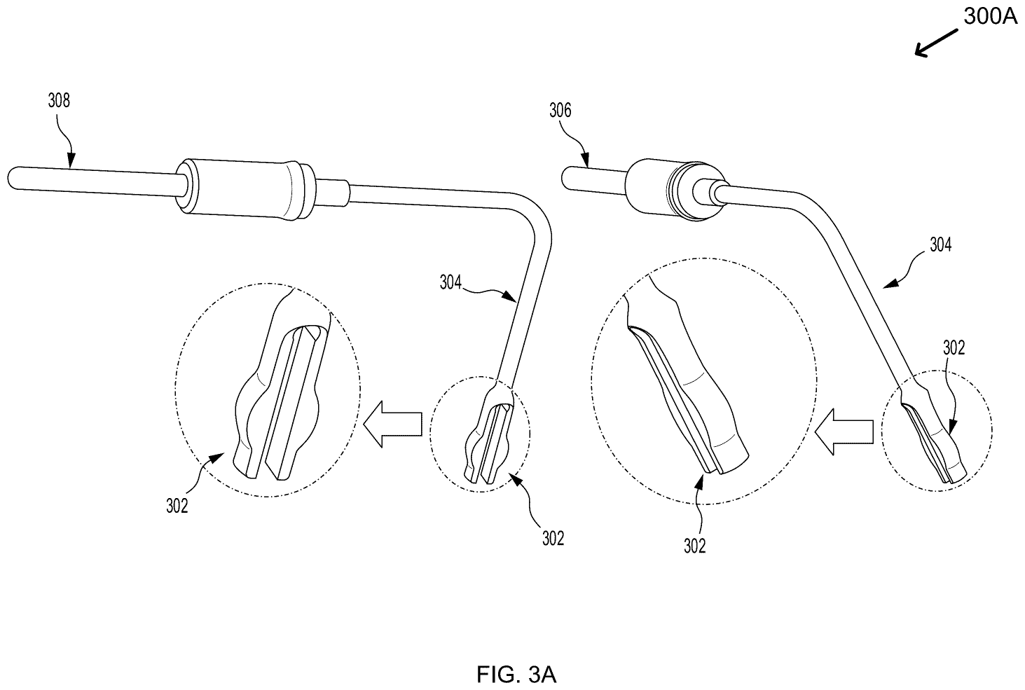

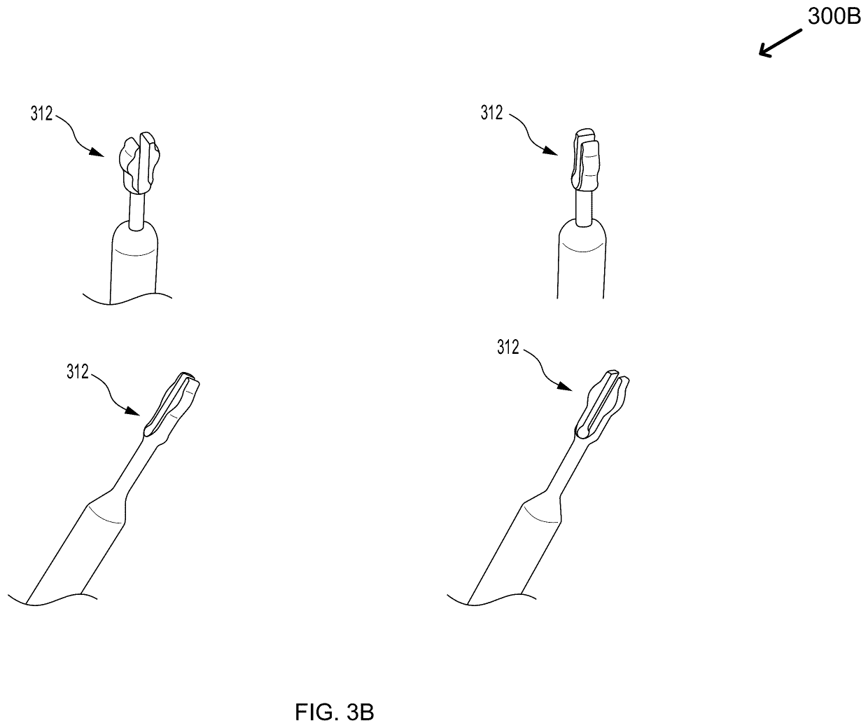

FIG. 3A illustrates perspective and close-up views of an example low-force, high mating durability, open-ended, compliant PC tail contact in 90-degree configuration, arranged in accordance with at least some embodiments described herein.

Diagram 300A shows side and rear perspective views with close-ups of the compliant portion 302 of a 90-degree, compliant PC tail contact according to examples. The contact has a contact portion 308, shown as a pin, but may also be a socket, and a tail portion 304 connecting the shoulder of the contact with the compliant portion 302 through a bend. As mentioned herein, the PC tail contact may have an angled bend (e.g., 90 degrees) or be a straight contact (0 degree). Split dimensions, number and shape of the deflectors (tines) may be selected based on PCB through-hole internal diameter and depth, number of contacts in the connector (density), application requirements, symmetry, spacing, or other considerations. In some examples, compliant portion 302 may also be a self-guiding lead-in feature for the PCB plated hole allowing the contacts to be inserted easily and in large numbers.

In some examples, the PC tail contact may be tunable based on a PC board thickness and/or mating force, where the contact bump/point that are part of the compliant portion 302 may be moved (up and down along the compliant portion 302) and the cantilever beam thickness may be adjusted. In other examples, the PC tail may be designed to have the inserting force to be low and extracting force to be higher if the shape of the contact bump/point is changed to a conical shape, for example.

FIG. 3B illustrates various perspective views of an example low-force, high mating durability, open-ended, compliant PC tail contact in straight configuration, arranged in accordance with at least some embodiments described herein.

Diagram 300B shows a straight compliant PC tail contact 312 implemented using gold plating with post-heat-treated beryllium copper pin material. As mentioned herein, the compliant PCT tail contact may be configured straight (0-degree), 45-degree angle, 90-degree angle, or any other angle depending on implementation. The dimensions discussed herein are examples of particular implementations. Other dimensions may be utilized depending on application-specific parameters such as PCB through-hole internal diameter and depth, number of contacts in the connector or connector size (density), symmetry, spacing, or otherconsiderations.

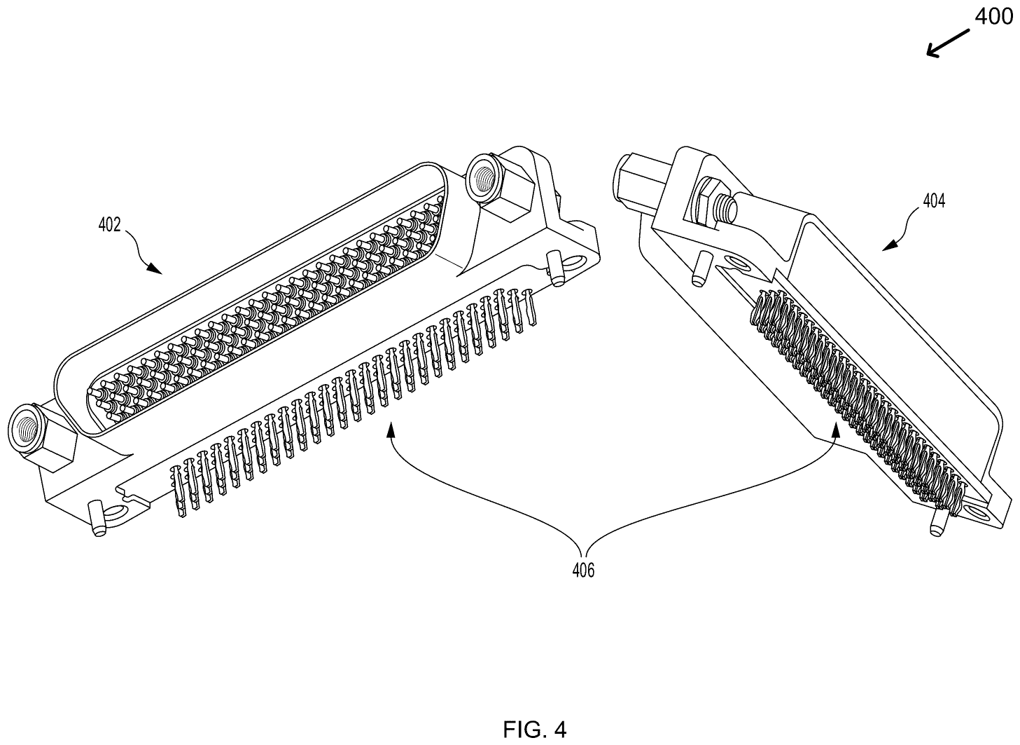

FIG. 4 illustrates implementation of an example low-force, high mating durability, open-ended, compliant PC tail contact in a D-SUB connector, arranged in accordance with at least some embodiments described herein. Compliant PC tail contacts according to examples may be implemented in various types of connector configurations including, but not limited to, circular, rectangular, etc.

Diagram 400 shows front and rear perspective views 402, 404 of a D-SUB connector with 90-degree PC tail contacts 406. The tail portions of the contacts 406 may be formed as low-force, high mating durability, open-ended, compliant pins providing low insertion force, increased contact surface, and increased through-hole depth range (shorter depths). Compliant PC tail contacts according to embodiments may be used on any other type of straight, 90-degree, or other-angled connectors in any number and configuration.

According to some examples, a compliant printed circuit (PC) tail contact includes a contact portion to mate with a corresponding contact; a shoulder portion coupled to the contact portion to position the PC tail contact within an insulator of a connector; a tail portion coupled to the shoulder portion; and a compliant pin coupled to the tail portion, the compliant pin comprising two or more deflectors with an open slit.

According to other examples, the compliant portion is to provide electrical contact with a printed circuit board (PCB) through insertion of the compliant portion into a PCB through-hole. The compliant portion may include two, three, or four deflectors based on one or more of an internal diameter of a PCB through-hole or a current to be carried by the PC tail contact. The tail portion may include an angled bend or may be straight. The two or more deflectors may provide 0.003 mil to 0.004 mil beam deflection per side. The contact portion may be a pin or a socket. A number and a shape of the two or more deflectors may be selected based on one or more of an internal diameter of a PCB through-hole or a current to be carried by the PC tail contact. One or more dimensions of the contact portion, the shoulder portion, the tail portion, or the compliant portion may be selected based on one or more of a connector type, an insulator size, a connector size, a number of contacts in the connector, or a layout of the contacts in the connector. The compliant portion may be configured as a self-guiding lead-in feature for a PCB through-hole such that a plurality of PC tail contacts are inserted efficiently and in largenumbers.

According to further examples, a printed circuit board (PCB) connector may include a connector shell; an insulator within the connector shell; and a plurality of printed circuit (PC) tail contacts positioned within the insulator. Each PC tail contact may include a contact portion to mate with a corresponding contact of another connector; a shoulder portion coupled to the contact portion to position the PC tail contact within the insulator of the PCB connector; a tail portion coupled to the shoulder portion; and a compliant portion coupled to the tail portion, the compliant portion comprising two, three, or four deflectors with an open slit based on one or more of an internal diameter of a PCB through-hole or a current to be carried by the PC tailcontact.

According to yet other examples, the compliant portion is to provide electrical contact with a PCB through insertion into PCT through-holes. The tail portion may include an angled bend or may be straight. A number and a shape of the two or more deflectors may be selected based on one or more of an internal diameter of a PCB through-hole or a current to be carried by the PC tail contact. One or more dimensions of the contact portion, the shoulder portion, the tail portion, or the compliant portion may be selected based on one or more of a connector type, an insulator size, a connector size, a number of contacts in the connector, or a layout of the contacts in the connector. The compliant portion may be configured as a self-guiding lead-in feature for a PCB through-hole such that a plurality of PC tail contacts are inserted efficiently and in large numbers. The contact portion may be a pin or a socket. The PCB connector may be a D-SUB connector.

According to yet further examples, a method for assembling a printed circuit board (PCB) connector with a plurality of compliant PC tail contacts may include positioning a shoulder portion of each PC tail contact in an insulator of the PCB connector such that a contact portion of each PC tail contact coupled to the respective shoulder portion is positioned inside a connector shell and inserting a compliant portion of each PC tail contact into a corresponding PCB through-hole, thereby coupling the PCB connector and a PCB. Each shoulder portion may be coupled to a corresponding tail portion. Each tail portion may be coupled to a corresponding compliant portion. Each shoulder portion may be straight or angled, and each compliant portion may include two or more deflectors with an open slit.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

I/WE Claim:

1. A compliant printed circuit (PC) tail contact comprising:
a contact portion to mate with a corresponding contact;
a shoulder portion coupled to the contact portion to position the PC tail contact within an insulator of a connector;
a tail portion coupled to the shoulder portion; and
a compliant pin coupled to the tail portion, the compliant pin comprising two or more deflectors with an open slit.

2. The compliant PC tail contact of claim 1, wherein the compliant portion is to provide electrical contact with a printed circuit board (PCB) through insertion of the compliant portion into a PCB through-hole.

3. The compliant PC tail contact of claim 1, wherein the compliant portion comprises two, three, or four deflectors based on one or more of an internal diameter of a PCB through-hole or a current to be carried by the PC tail contact.

4. The compliant PC tail contact of claim 1, wherein the tail portion includes an angledbend.

5. The compliant PC tail contact of claim 1, wherein the tail portion is straight.

6. The compliant PC tail contact of claim 1, wherein the two or more deflectors provide 0.003 mil to 0.004 mil beam deflection per side.

7. The compliant PC tail contact of claim 1, wherein the contact portion is a pin or a socket.

8. The compliant PC tail contact of claim 1, wherein a number and a shape of the two or more deflectors are selected based on one or more of an internal diameter of a PCB through-hole or a current to be carried by the PC tail contact.

9. The compliant PC tail contact of claim 1, wherein one or more dimensions of the contact portion, the shoulder portion, the tail portion, or the compliant portion are selected based on one or more of a connector type, an insulator size, a connector size, a number of contacts in the connector, or a layout of the contacts in the connector.

10. The compliant PC tail contact of claim 1, wherein the compliant portion is configured as a self-guiding lead-in feature for a PCB through-hole such that a plurality of PC tail contacts are inserted efficiently and in large numbers.

11. A printed circuit board (PCB) connector, comprising:
a connector shell;
an insulator within the connector shell; and
a plurality of printed circuit (PC) tail contacts positioned within the insulator, each PC tail contact comprising:
a contact portion to mate with a corresponding contact of another connector;
a shoulder portion coupled to the contact portion to position the PC tail contact within the insulator of the PCB connector;
a tail portion coupled to the shoulder portion; and
a compliant portion coupled to the tail portion, the compliant portion comprising two, three, or four deflectors with an open slit based on one or more of an internal diameter of a PCB through-hole or a current to be carried by the PC tail contact.

12. The PCB connector of claim 11, wherein the compliant portion is to provide electrical contact with a PCB through insertion into PCT through-holes.

13. The PCB connector of claim 11, wherein the tail portion includes an angled bend.

14. The PCB connector of claim 11, wherein the tail portion is straight.

15. The PCB connector of claim 11, wherein a number and a shape of the two or more deflectors are selected based on one or more of an internal diameter of a PCB through-hole or a current to be carried by the PC tail contact.

16. The PCB connector of claim 11, wherein one or more dimensions of the contact portion, the shoulder portion, the tail portion, or the compliant portion are selected based on one or more of a connector type, an insulator size, a connector size, a number of contacts in the connector, or a layout of the contacts in the connector.

17. The PCB connector of claim 11, wherein the compliant portion is configured as a self-guiding lead-in feature for a PCB through-hole such that a plurality of PC tail contacts are inserted efficiently and in large numbers.

18. The PCB connector of claim 11, wherein the contact portion is a pin or a socket.

19. The PCB connector of claim 11, wherein the PCB connector is a D-SUBconnector.

20. A method for assembling a printed circuit board (PCB) connector with a plurality of compliant PC tail contacts, the method comprising:
positioning a shoulder portion of each PC tail contact in an insulator of the PCB connector such that a contact portion of each PC tail contact coupled to the respective shoulder portion is positioned inside a connector shell;
inserting a compliant portion of each PC tail contact into a corresponding PCB through-hole, thereby coupling the PCB connector and a PCB, wherein
each shoulder portion is coupled to a corresponding tail portion,
each tail portion is coupled to a corresponding compliant portion,
each shoulder portion is straight or angled, and
each compliant portion includes two or more deflectors with an openslit.
